(19) United States
(12) Patent Application Publication
(10) Pub. No.: US 2026/0213103 A1
(43) Pub. Date: Jul. 23, 2026

(54) RELAY EQUIPPED WITH ON/OFF CONTACT DETECTION MECHANISM

(71) Applicant: OMRON Corporation, Kyoto-shi, Kyoto (JP)

(72) Inventors: Hiroyuki IWASAKA, Kyoto-shi, Kyoto (JP); Ryota MINOWA, Kyoto-shi, Kyoto (JP); Shinichi OGAWA, Kyoto-shi, Kyoto (JP); Hiroyuki HARIMOCHI, Kyoto-shi, Kyoto (JP); Ayata HORIE, Kyoto-shi, Kyoto (JP)

(21) Appl. No.: 18/262,918

(22) PCT Filed: Jan. 18, 2022
(86) PCT No.: PCT/JP2022/001525

§ 371 Date: Sep. 3, 2025

(30) Foreign Application Priority Data
Feb. 3, 2021 (JP) 2021-015915

(51) Int. Cl. H01H 50/64; H01H 50/02; H01H 50/54

(52) U.S. Cl. CPC H01H 50/641; H01H 50/02; H01H 50/546

(57) ABSTRACT

This is to provide a high-capacity relay equipped with an ON/OFF contact detection mechanism that detects “ON/OFF” (opened or closed) state of the relay for safety requirements, which eliminates time lag of the contact detection and has small restrictions in terms of space and installation structure for equipping the contact detection mechanism. In one embodiment, the relay comprises: (1) a plunger actuator that actuates a plunger shaft so as to switch its axial position; (2) an ON/OFF contact section that accommodates an ON/OFF actuating-end portion of the plunger shaft and comprises a movable contact, which is connected to the ON/OFF actuating-end portion in a manner not to be displaced in axial direction, and a stationary contact, to and from which the movable contact is contacted and separated; and (3) an ON/OFF contact detector that accommodates another end portion of the plunger shaft, performs ON/OFF action in response to switching of axial position of the plunger shaft, and output a signal of the ON/OFF action.

### CROSS-REFERENCE TO RELATED APPLICATION

This application is the U.S. National Phase of International Application No. PCT/JP 022/001525, filed on Jan. 18, 2021. This application claims priority to Japanese Patent Application No. 2020-042427, filed Jan. 18, 2022. The contents of those applications are incorporated by reference herein in their entireties.

### FIELD

The present invention relates to a relay equipped with a mechanism for detecting whether a relay contact is open or closed (“ON” or “OFF”). In particular, the present invention relates to high-capacity relays of 100V or more and 10A or more, for example, being used for rapid charging of electric vehicles, various power storage systems, elevators, industrial robots, and the like.

### BACKGROUND

Gas-filled relays (gas-tight, gas-filled relays) are generally used as relays that enable emergency shutdown of high current and high capacity such as DC power relays. Gas-filled relays typically include: (i) a plunger actuator by means of a solenoid or the like; (ii) a gas-filled chamber that is arranged above the plunger actuator and filled with a gas that has an arc cooling effect; (iii) an ON/OFF contact section that is arranged within the gas-filled chamber and driven by a plunger; and (iv) a permanent magnet arranged along a lateral wall of the gas-filled chamber to achieve an arc-stretching effect.

In high-capacity relays or the like, a detection mechanism enabling mechanical detection of the ON/OFF contacts would be needed to sufficiently ensure the safety of devices that receive power supply, such as quick charging devices. As such a detection mechanism, it has been proposed to equip the relay with an “auxiliary contact” that opens and closes so as to track and imitate opening and closing of the ON/OFF contact, which cuts off and supplies power supply (US 2019/0228938A, US2013/0154775A and WO2018/056523A1). The signal of opening and closing of such “auxiliary contact” is transmitted to the outside so as to enable monitoring on the operating state of the ON/OFF contact section (“main contact”) that is for controlling of power supply.

In US 2019/0228938A, internal space of the casing, which is located above the solenoid, is partitioned by a partition wall to form a second accommodating part (13) for an auxiliary contact while a movable contact for the auxiliary contact, together with a movable contact for the “main contact”, is connected to upper end of a plunger shaft (driving shaft 50). In US2013/0154775A, an auxiliary contact mechanism (30) is installed on a flank of an excitation coil (20) of a solenoid; an “auxiliary contact pressing portion 10a” is formed integrally with a “slide support member 10” for opening and closing the “main contact”; and the “auxiliary contact” is opened and closed by the “auxiliary contact pressing portion 10a”. Meanwhile, in WO2018/056523A1, an “auxiliary contact” (150) is formed above the plunger (shaft 160), on a ceiling wall of a storage chamber corresponding to a gas-filled chamber, and the plunger goes upward and abuts against the “auxiliary contact” (150) to open it.

### SUMMARY

There were many restrictions in terms of space and installation structure when an airtight gas-filled chamber has been used in a high-capacity relay or the like, with conventional contact-ON/OFF detection mechanisms such as those of Patent Documents 1 to 3. Moreover, timing of operation may be deviated if movable terminal of the contact switching part (“main contact”) is not necessarily integrated with movable part of the auxiliary contact and a spring is placed between the plunger and the movable terminal.

### Solution to Problems

In a preferred embodiment, a relay having a ON/OFF contact detection mechanism includes: (1) a plunger actuator that actuates a plunger shaft so as to switch its axial position; (2) an ON/OFF contact section that accommodates an ON/OFF actuating-end portion of the plunger shaft and comprises a movable contact, which is connected to the ON/OFF actuating-end portion in a manner not to be displaced in axial direction, and a stationary contact, to and from which the movable contact is contacted and separated; and (3) an ON/OFF contact detector that accommodates another end portion of the plunger shaft, performs ON/OFF action in response to switching of axial position of the plunger shaft, and output a signal of the ON/OFF action.

In a preferred embodiment, the ON/OFF contact detector may comprise a switch that is activated by pushing and returning a lever or key. Further, in a preferred embodiment, the ON/OFF contact detector may be set to always be “ON” (closed) during a period in which the ON/OFF contact section is “OFF” (open).

In a preferred embodiment, the plunger shaft may comprise a shaft main body and a tube-shaped portion on outside of the shaft main body, on a side near the ON/OFF contact section, and includes a jacket part for receiving a coil spring therein while the ON/OFF actuating-end portion includes: a basal portion having an outer diameter equal to or larger than that of the jacket part; a rivet shank extending from a central axis portion of the basal portion and piercing the movable contact portion; and a rivet foot jutting out from the movable contact portion. Here, the rivet shank and rivet foot refer to those forming a fixing-holding structure same or similar to those of riveting and caulking even without using the riveting and caulking.

In a preferred embodiment, the relay further comprises: a casing that houses the ON/OFF contact section and the plunger actuator altogether; and a space that is formed between the ON/OFF contact section and inner wall of the casing; wherein, in the casing, the ON/OFF contact section is arranged at above the plunger actuator; and the contact ON/OFF detector receives upper-end portion of the plunger shaft.

### Advantageous Effects of Invention

According to a preferred embodiment, at least one of the following effects (i) to (iv) is obtainable.
(i) In real time without timing deviation, ON/OFF state of the ON/OFF contact section is able to be detected and monitored.
(ii) For the ON/OFF contact detector, a common mechanical switch or the like is properly applicable; and thus, it is able to optimize level and conditions of the detection. In particular, the ON/OFF contact detector is easily set in a manner that it is always “ON” throughout a period when the ON/OFF contact section is “OFF”; thereby fail-safe use is easily achieved.
(iii) A conversion between a relay design having the ON/OFF contact detector and a relay design not having the ON/OFF contact detector may be easily achievable, almost only by attaching or detaching a unit of the ON/OFF contact detector on outer face of the casing. As a result, most of the parts/members, manufacturing equipment and processes are able to be used in such relay designs; thus, costs and workloads for manufacturing will be decreased.
(iv) A relay will be operated at high-capacity without being gas-filled.

### BRIEF DESCRIPTION OF THE DRAWINGS

FIG. 1 is an axial cross-sectional perspective view of an embodiment relay.

FIG. 2 is a perspective view of the relay of FIG. 1.

FIG. 3 is an enlarged cross-sectional perspective view showing an essential portion (in vicinity of the opening/closing actuation-end portion of the plunger shaft) of FIG. 1.

FIG. 4 is a simple graph for explaining operation settings of the contact switch.

### DETAILED DESCRIPTION

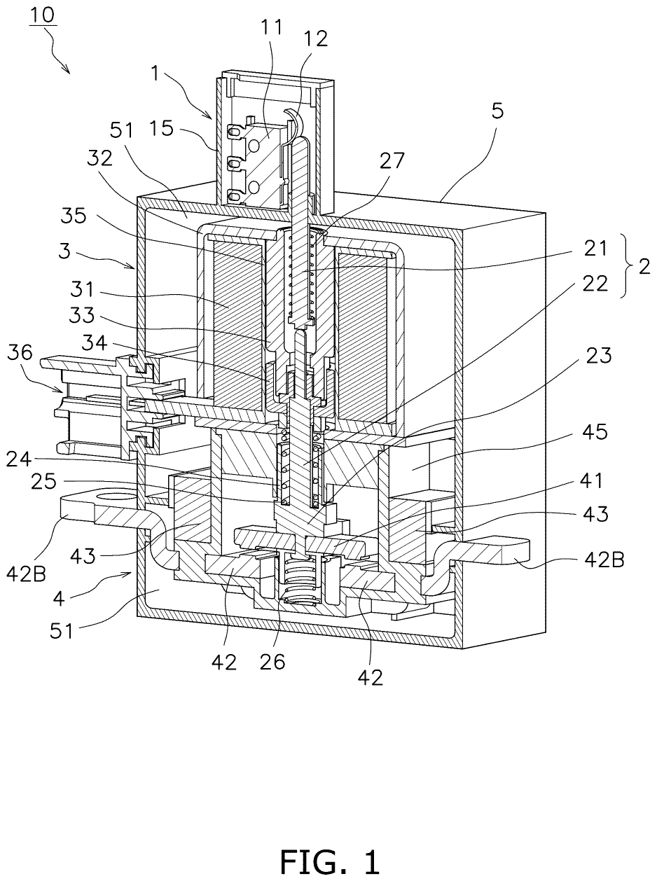

The relay of the embodiment of the present application will be explained using FIGS. 1-4.

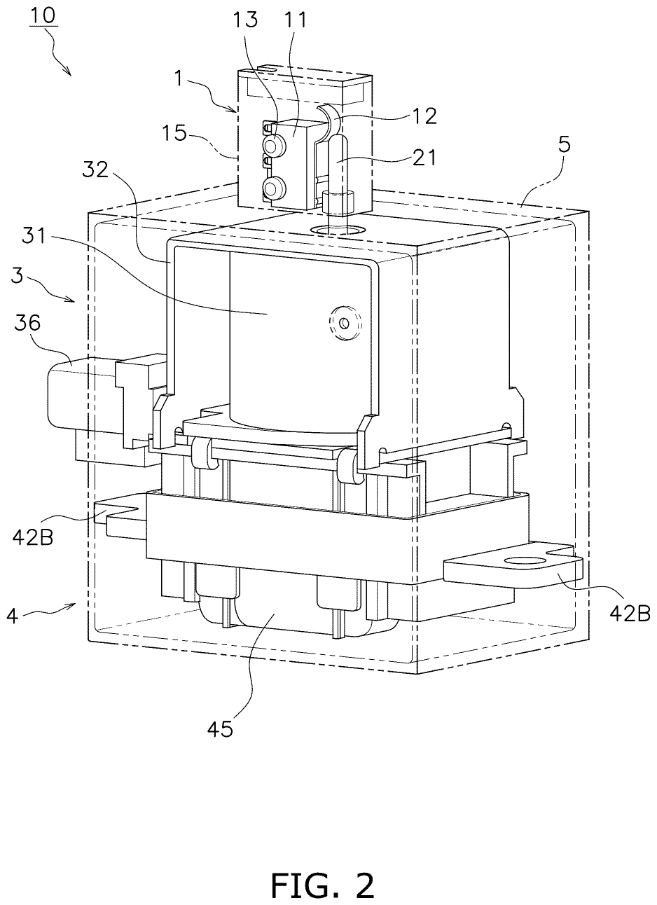

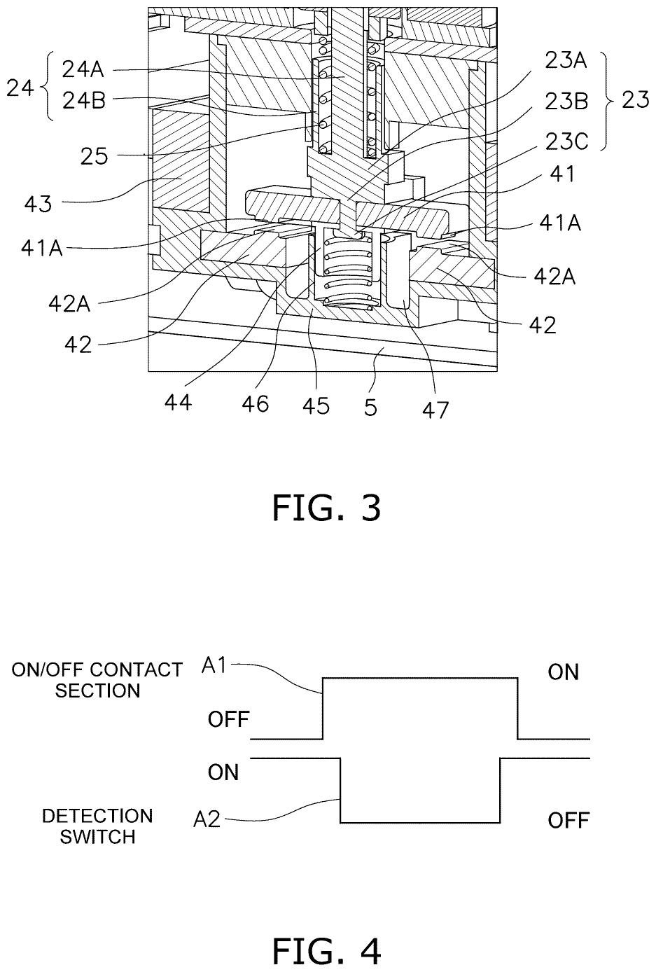

Fig. I is a cross-sectional perspective view of the high-capacity relay of the embodiment, along central axis of the plunger shaft. FIG. 2 is a perspective view of the relay of FIG. 1, as viewed from a direction same with a viewing direction of FIG. 1 and with the casing shown in phantom for clarity of the figure. FIG. 3 is a partially enlarged view showing the vicinity of the actuation-end portion of the plunger shaft. FIG. 4 is a schematic signal chart for explaining the setting of the detection switch.

The high-capacity relay 10 has a contact detector unit 1 at its upper end. In this contact detector unit 1, the switch lever 12 of the detection switch 11 is pressed in response to vertical movement of the auxiliary shaft 21, and then returns to initial position. Accordingly, detection signal (“A2” in FIG. 4) is output from the detection switch 11. The detection switch 11 and the upper end of the auxiliary shaft 21 are housed in a rectangular parallelepiped cup-shaped detection unit casing 15.

As shown in FIG. 2, the detection switch 11 is provided with an adjustment/fixing screw 13, which is for adjusting a detection level of the contact position of the detection switch 11, and is for maintaining such adjusted state. The adjustment/fixing screw 13 is exposed on the outer surface of the detection unit casing 15 and thus, is able to be easily manipulated.

A plunger shaft 2 is formed of the auxiliary shaft 21 together with the plunger 22. In the illustrated example, although the auxiliary shaft 21 and the plunger 22 are separate from each other, they are axially pressed against each other due to the action of a return spring 26 and an auxiliary shaft spring 27 attached to the auxiliary shaft 21. Therefore, the axial positions of the auxiliary shaft 21 and the plunger 22 do not deviate from each other.

The detection unit casing 15 is formed separately or integrally with the main casing 5 and arranged on the upper surface of the main casing 5. In the illustrated example, the main casing 5 shaped as a rectangular parallelepiped accommodates a plunger driving section 3 on upper side together with a ON/OFF contact section 4 on lower side.

The plunger actuator 3 includes: a coil 31; a yoke 32 at surrounding of the coil; a movable core 34 at inner side; a stator iron core 33 at above the movable core; a bobbin 35 around which the coil 31 is wound; and a coil input section 36. In the illustrated example, the auxiliary shaft 21 and the plunger 22 abut against each other at inside of the fixed core 33, in the axial direction.

In the ON/OFF contact section 4, the ON/OFF actuating-end portion 23 of the plunger shaft 2 is accommodated in a working chamber inside the cup-shaped ON/OFF contact-section casing 45. The ON/OFF contact section 4 comprises: a movable terminal 41, which is not-movably connected to the ON/OFF actuating-end portion 23; and stationary terminals 42 on right-hand and left-hand sides, which are arranged on bottom surface of the ON/OFF contact-section casing 45. Permanent magnets 43 for arc extension are attached on outer faces of lateral walls, on right-hand and left-hand sides, of the ON/OFF contact-section casing 45.

The movable terminals 41 and the stationary terminals 42, on right-hand and left-hand sides, are made of a rigid metal thick plate or the like. The movable terminal 41 is a metal body or a metal plate, which extends horizontally in leftward/rightward direction, and has a movable contact 41A, which is formed on bottom surface of right-hand and left-hand end portions of the movable terminal 41, as a bar-shaped convex portion extending in the front-rear direction. The stationary terminals 42 on right-hand and left-hand sides are also made of a similar metal body or metal plate, and have stationary contacts 42A, which are formed on upper surfaces of right-hand and left-hand inward end portions of the stationary terminals 42.

A return spring 26, which is a coil spring exhibiting a relatively strong spring force, is arranged below the ON/OFF actuating-end portion 23 of the plunger shaft 2. In the illustrated example, the lower end of the ON/OFF actuating-end portion 23 and a tubular first resin guide tube 44 connected to the movable terminal 41 are downwardly extended. The first resin guide tube 44 is slidably inserted into and engaged with a second resin guide tube 46, which extends upward from central portion of bottom surface of the ON/OFF contact-section casing 45. Such inserting and engaging prevents the plunger shaft 2 from being displaced in horizontal direction at a time the position of the plunger shaft 2 is switched in the axial direction so as to make ON/OFF actuation.

In an example shown in FIGS. 3 and 1, a depression 47 is formed in central portion of the bottom surface of the ON/OFF contact-section casing 45. In the depression 47, the lower half of the second resin guide tube 46 is accommodated. Thus, the return spring 26 having a large vertical dimension and a large diameter are able to be arranged. Upper half of the return spring 26 is inserted into and engaged with the first resin guide tube 44.

The plunger shaft 2 has a jacket part 24 that receives the contact spring 25 on a side near to the contact-ON/OFF portion 4. The contact spring 25 induces a spring force for pushing downward the plunger 22 of the plunger shaft 2. The jacket part 24 is formed of a shaft body portion 24A and an outer tube-shaped portion 24B, and the lower ends of these two portions are continuous with the ON/OFF actuating-end portion 23.

The ON/OFF actuating-end portion 23 includes: a basal body 23A, which is shaped as a short circular-column and has a diameter larger than or same as that of the jacket part 24; a rivet shank 23B, which is extended downward from lower end of central portion of the basal body 23A and pierces through the movable terminal 41; and a rivet foot 23C, which is further extended from lower end of the rivet shank 23B. In other words, the ON/OFF actuating-end portion 23 having a large diameter is firmly connected with the rigid movable terminal 41 by a method such as caulking, as if they were integrally formed, so that their positions and postures are not able to be displaced from each other.

As a result, the movable contact 41A and the plunger 22 are not able to be displaced from each other, in the axial direction (vertical direction). In addition, the plunger 22 and the auxiliary shaft 21 are pressed against each other from above and below by the springs 27 and 26 as described above; and thus are not able to be displaced from each other. Therefore, the vertical movement of the movable contact 41A is accurately transmitted to the upper end of the auxiliary shaft 21 without time lag.

On the other hand, as shown in FIGS. 1 to 3, spaces 51 are formed along inner surfaces of the main casing 5, on its upper, lower, front, rear, right-hand and left-hand sides. On the upper side of the main casing 5, such space 51 is formed between the yoke 32 and inner surface of the main casing 5. Meantime, on the lower side of the main casing 5, such space 51 is formed between the ON/OFF contact-section casing 45 and inner surface of the main casing 5. Air or gas for cooling is able to be circulated through such space 51. In this way, filling the inside with a gas can be eliminated.

In many occasions, it is preferable that the ON/OFF contact section 4 is located on the lower side as described in present embodiment so that introduced cooling air or the like is headed to the ON/OFF contact section 4 at first. Nevertheless, the relay may be turned upside down, and is of course able to be used in a state being laid sideways or being diagonally arranged.

FIG. 4 schematically shows a typical example of the operation setting of the detection switch 11, using a pulse wave chart. As observed here, rising of a pulse wave A1, which indicates ON/OFF of the contact switch 4, is immediately followed by falling of the pulse wave A2, which indicates ON/OFF of the detection signal of the detection switch 11. Further, as observed here, the pulse wave A2 of the detection switch 11 rises just before falling of the pulse wave A1 of the ON/OFF contact section 4.

Such a way of the operation enables, in a high-capacity relay or the like for example, that the output signal of the detection switch 11 is in “ON” state only while the current-cutoff mechanism is in operating state. Thus, a kind of fail-safe mechanism is adoptable. Further, as described above, the adjustment/fixing screw 13, which is for adjusting detection position of the detection switch 11, is exposed to the outside and thus is able to be easily manipulated. That is, it is able to adjust the detection position to the optimum and maintain such optimum in a much easier manner than when using the auxiliary contact of the prior art.

In the above explanation, although the detection switch 11 was described as a mechanical switch having a lever or a push-down key, detection switch 11 may, depending on situation, be one based on optical detection.

On the other hand, when the plunger shaft 2 is formed of two separate members—the plunger 22 and the auxiliary shaft 21 as described above, the design of the relay is easily convertible between one having the contact ON/OFF detector unit 1 and one not having the detector unit 1, only by replacing the auxiliary shaft 21 for example. Moreover, design of the contact ON/OFF detector unit 1 may be easily converted to other one.

Nevertheless, the plunger 22 and the auxiliary shaft 21, which form the plunger shaft 2, may be integrally formed or joined by screwing or welding. Moreover, the plunger shaft 2 may be formed of two or more members.

In the present embodiment, the plunger-actuator 3 is described as being based on a solenoid, but it is also possible to adopt another electromagnetic drive mechanism or a drive mechanism using a piezo element or the like.

### REFERENCE NUMERALS

1 ON/OFF contact detector unit
10 High-capacity relay
11 Detection switch
12 Switch lever
13 Screws for adjusting/fixing the detection position
15 Detector casing
2 Plunger shaft
21 Auxiliary shaft
22 Plunger
23 ON/OFF actuating-end portion
23A Basal body 23B Rivet shank 23C Rivet foot
24 Jacket part 24A Shaft body portion 24B Tube-shaped portion
25 Contact spring
26 Return spring
27 Auxiliary shaft spring
3 Plunger actuator
31 Coil
32 York
33 Stationary iron core
34 Movable iron core
35 Bobbin
36 Coil input section
4 ON/OFF contact section
41 Horizontal thick plate-shaped movable terminal 41A Movable contact
42 Stationary terminal 42A Stationary contact 42B Input/output terminal
43 Permanent magnet
44 First resin guide tube
45 ON/OFF contact-section casing
46 Second resin guide tube
47 Depression
5 Main casing
51 Space along inner wall surface of the main casing
A1 ON/OFF of the ON/OFF contact section A2 ON/OFF of the ON/OFF contact detector

1. A relay comprising:
plunger actuator that actuates a plunger shaft so as to switch its axial position;
an ON/OFF contact section that accommodates an ON/OFF actuating-end portion of the plunger shaft and comprises a movable contact, which is connected to the ON/OFF actuating-end portion in a manner not to be displaced in axial direction, and a stationary contact, to and from which the movable contact is contacted and separated;
an ON/OFF contact detector that accommodates another end portion of the plunger shaft, performs ON/OFF action in response to switching of axial position of the plunger shaft, and output a signal of the ON/OFF action.

2. The relay according to claim 1, wherein the ON/OFF contact detector includes a switch that is activated by pressing and returning a lever or key.

3. The relay according to claim 1, wherein the ON/OFF contact detector is set to always be “ON” during a period in which the ON/OFF contact section is “OFF”.

4. The relay according to claim 1, wherein
the plunger shaft comprises, at a side near to the ON/OFF contact section, a jacket part that comprises a shaft main body and a tube-shaped part and receives at its inside a coil spring;
the ON/OFF actuating-end portion comprises: a short-columnar basal body having an outer diameter same or larger than that of the jacket part; a rivet shank that extends from a central axis portion of the basal body and pierces through the movable contact; and a rivet foot jutting out from the movable contact.

5. The relay according to claim 1, further comprising
a casing that houses the ON/OFF contact section and the plunger actuator altogether; and
a space that is formed between the ON/OFF contact section and inner wall of the casing;
wherein, in the casing, the ON/OFF contact section is arranged at above the plunger actuator; and
the contact ON/OFF detector receives upper-end portion of the plunger shaft.
